(19) United States
(12) Patent Application Publication
(10) Pub. No.: US 2004/0264976 A1
(43) Pub. Date: Dec. 30, 2004

(54) Optical signal quality monitoring apparatus

(76) Inventors: Hoon Kim, Suwon-shi (KR); Yun-Je Oh, Yongin-shi (KR); Seong-Taek Hwang, Pyongtaek-shi (KR)

Correspondence Address: Steve S. Cha, Esq., CHA & REITER, 9TH FLOOR, 411 HACKENSACK AVE, HACKENSACK, NJ, 07601, US

(21) Appl. No.: 10/717,265

(22) Filed: Nov. 19, 2003

(30) Foreign Application Priority Data
Jun. 28, 2003 (KR) 2003-42926

(51) Int. Cl. H04B 10/00

(52) U.S. Cl. 398/155

(57) ABSTRACT

An optical signal quality monitoring apparatus includes an optical coupler for performing a coupling operation for an input optical signal, a first photodetector (PD) for converting the input optical signal into an electrical signal, a clock decision recovery (CDR) unit for detecting a clock from the electrical signal and recovering data on the basis of the detected clock, and a monitoring unit. The monitoring unit includes a second PD for receiving an output optical signal from the optical coupler and converting it into an electrical signal, an amplifier for amplifying the electrical signal to a predetermined level and inverting the amplified signal, an adder for adding the amplified/inverted signal to a recovered data signal from the CDR unit to obtain a difference there between, a band pass filter for band pass filtering an output signal from the adder, and a radio-frequency power detector for measuring radio-frequency power from an output signal from the band pass filter.

### CLAIM OF PRIORITY

This application claims priority to an application entitled “OPTICAL SIGNAL QUALITY MONITORING APPARATUS,” filed in the Korean Intellectual Property Office on Jun. 28, 2003 and assigned Serial No. 2003-42926, the contents of which are hereby incorporated by reference.

### BACKGROUND OF THE INVENTION

1. Field of the Invention

The present invention relates to an optical communication system, and more particularly to an optical signal quality monitoring apparatus for monitoring the quality of an optical signal transmitted through an optical cable in an optical communication system.

2. Description of the Related Art

In general, the monitoring of the quality of an optical signal transmitted through an optical transmission line, such as an optical cable, in an optical communication system can be roughly classified into two methods, one being a method based on an optical layer and the other being a method based on an electrical layer.

The optical layer-based optical signal quality monitoring method is adapted to measure basic optical characteristics of an optical signal and, in turn, the quality of the optical signal on the basis of the measured results. Quality is typically assessed based on the measured power level, signal-to-noise ratio (SNR), Q factor, etc. of the optical signal to monitor the quality of an optical signal at any position of an optical transmission line, as well as in a receiver. The optical layer-based optical signal quality monitoring method can be implemented at a relatively low cost in that there is no need to decode frame information one frame at a time.

On the other hand, the electrical layer-based optical signal quality monitoring method is adapted to convert an optical signal into an electrical signal, decode frame information of the converted electrical signal one frame at a time and monitor the quality of the optical signal on the basis of the decoded frame information. The electrical layer-based monitoring method generally uses a method for calculating a parity code of an optical signal transmitted in a synchronous optical network/synchronous digital hierarchy (SONET/SDH) optical transmission system. The quality of an optical signal can be measured only in a receiver. However, this monitoring method can measure the quality of an optical signal relatively accurately because it directly decodes frame information individually frame-by-frame to monitor errors.

FIG. 1 shows the structure of an optical signal frame used in a conventional parity code-based optical signal quality monitoring method applied to an SONET/SDH optical transmission system.

The SONET/SDH optical signal frame is basically composed of a head and a payload. The head includes a section overhead, a line overhead and a path overhead. The section overhead is provided with a section parity byte B1, the line overhead is provided with a line parity byte B2, and the path overhead is provided with a path parity byte B3.

The parity byte B1 is produced by generating an 8-bit bit interleaved parity (BIP) code with respect to the preceding SONET/SDH STS-N frame. As a result, the monitoring method can detect an 8-bit error at maximum with the byte B 1. The causes of errors in the byte B 1 may be, for example, uncleanliness of a fiber-optic connector, sharp bending of an optical fiber, a very low received power level, errors in a transmitter and receiver, etc.

The parity byte B2 is produced by generating an 8-bit BIP code with respect to a line overhead and payload. Possible causes of errors in the byte B2 include, for example, an error in a regenerator in addition to the causes of errors in the byte B 1.

The parity byte B3 is produced by generating an 8-bit BIP code with respect to a payload before scrambling. Possible causes of errors in the byte B3 include, for example, an error in path terminating equipment in addition to the causes of errors in the bytes B1 and B2. An SONET/SDH receiver monitors whether an error is present in a received frame by decoding the received frame, reading and calculating parity bytes B1, B2 and B3 therein and comparing the calculated results of the parity bytes B1, B2 and B3 with those of parity bytes B1′, B2′ and B3′ in the next received frame.

However, the conventional electrical-layer based optical signal quality monitoring method is limited to quality assessment of SONET/SDH frames only, and is not operable outside that standard. Further, the conventional optical signal quality monitoring method uses a method for directly calculating a parity error rate on an optical signal frame basis. A long time is consequently required to measure the quality of an optical signal having a low bit error rate (BER) such as 10⁻¹², because a long time is required to find the low BER.

### SUMMARY OF THE INVENTION

The present invention has been made in view of the above problems, and, in one aspect, provides an optical signal quality monitoring apparatus which is capable of monitoring the quality of an optical signal more simply and conveniently irrespective of a frame type of the optical signal.

In another aspect, the present invention provides an optical signal quality monitoring apparatus which is capable of, in an optical receiver, monitoring the quality of an optical signal at a low cost irrespective of a frame type of the optical signal.

It is yet another aspect of the present invention to provide an optical signal quality monitoring apparatus which is capable of reducing time required for measuring the quality of an optical signal.

Briefly, the above and other aspects can be accomplished by the provision of an optical signal quality monitoring apparatus that includes an optical coupler for performing a coupling operation for an input optical signal; a photo detector (PD) for converting the input optical signal into an electrical signal; a clock decision recovery (CDR) unit for detecting a clock from the electrical signal from the PD and recovering data on the basis of the detected clock; and monitoring unit. The monitoring unit converts an output optical signal from the optical coupler into an electrical signal, invert/amplifies the converted electrical signal to a predetermined level, synthesizes the inverted/amplified signal with a recovered data signal from the CDR unit to obtain a difference there between, band pass filters the resulting difference signal and measures radio-frequency power from the filtered result, the radio-frequency power being an error value of the input optical signal.

In another embodiment, a single PD performs the function of the two PDs. In further embodiments, the two signals to be differences are band-passed filtered by respective filters before the differencing in respective embodiments that include either the single PD or the two PDs.

### BRIEF DESCRIPTION OF THE DRAWINGS

The above and other aspects, features and other advantages of the present invention will be more clearly understood from the following detailed description taken in conjunction with the accompanying drawings, in which the same or similar features are denoted by identical numerals throughout the several views:

FIG. 1 is a view showing the structure of an optical signal frame used in a conventional parity code-based optical signal quality monitoring method applied to an SONET/SDH optical transmission system;

FIG. 2 is a block diagram showing a first embodiment of an optical signal quality monitoring apparatus in accordance with the present invention;

FIG. 3 is a block diagram showing a second embodiment of the optical signal quality monitoring apparatus in accordance with the present invention;

FIGS. 4a to 4c are waveform diagrams of signals outputted from blocks in FIGS. 2 and 3;

FIG. 5 is a block diagram showing a third embodiment of the optical signal quality monitoring apparatus in accordance with the present invention;

FIG. 6 is a block diagram showing a fourth embodiment of the optical signal quality monitoring apparatus in accordance with the present invention; and

FIGS. 7a to 7c are waveform diagrams of signals outputted from blocks in FIGS. 5 and 6.

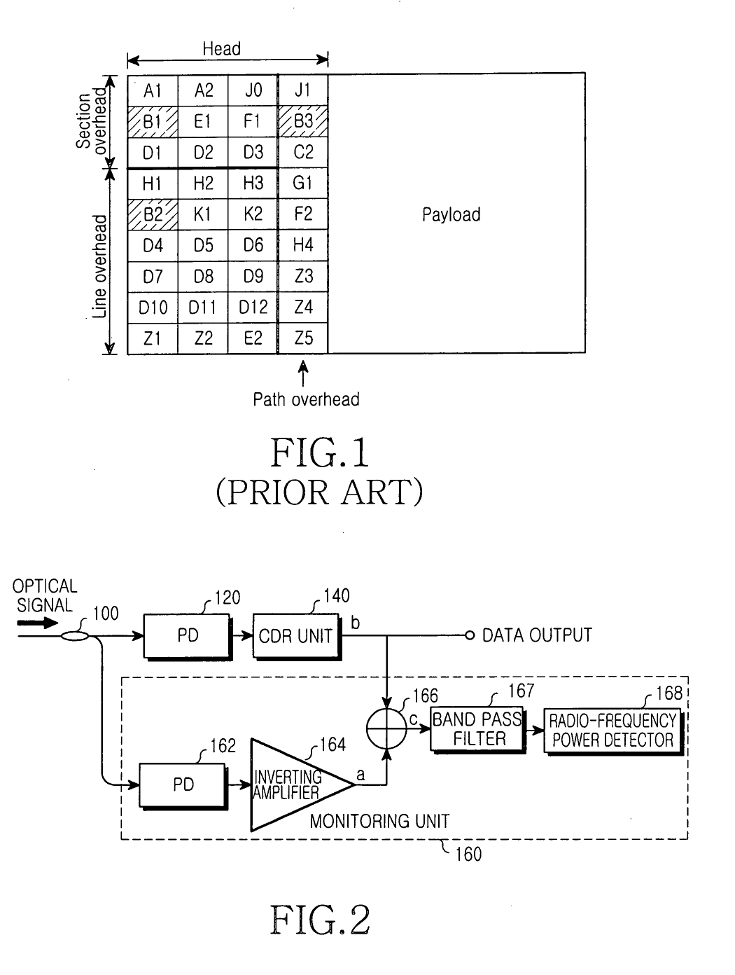

### DETAILED DESCRIPTION OF THE PREFERRED EMBODIMENTS

Preferred embodiments of the present invention are described below in detail with reference to the annexed drawings. In the following description, a variety of specific elements such as constituent elements of various concrete circuits are shown. The description has been provided merely to afford a better understanding of the present invention, and those skilled in the art will appreciate that the present invention can be implemented by alternative means. Detailed description of known functions and configurations incorporated herein has been omitted for clarity of presentation.

With reference to FIG. 2, and by way of illustrative non-limitative example, an optical signal quality monitoring apparatus in accordance with a first embodiment of the present invention includes an optical coupler 100, a photo detector (PD) 120, a clock decision recovery (CDR) unit 140 and a monitoring unit 160.

The optical coupler 100 performs a coupling operation for an input optical signal. The PD 120 converts the input optical signal into an electrical signal. The CDR unit 140 detects a clock from the electrical signal from the PD 120 and recovers data on the basis of the detected clock. The monitoring unit 160 includes a PD 162, an inverting amplifier 164, an adder 166, a band pass filter 167 and a radio-frequency power detector 168. The radio-frequency power detector 168 is preferably communicatively connected to a processor (not shown) that may include notification means such as a display screen, storage for logging error information and/or analysis means by which to determine the source of the error and to automatically correct the input optical signal.

The PD 162 receives the output optical signal from the optical coupler 100 and converts it into an electrical signal. The inverting amplifier 164 amplifies the electrical signal from the PD 162 to a predetermined level and inverts the phase of the amplified signal.

The adder 166 synthesizes the amplified/inverted signal from the inverting amplifier 164 with the output signal from the CDR unit 140. The band pass filter 167 performs a band pass filtering operation of passing an output signal from the adder 166 at a predetermined band. The radio-frequency power detector 168 measures radio-frequency power from an output signal from the band pass filter 167. Preferably, the radio-frequency power detector 168c an measure radio-frequency power E on the basis of the following equation 1:

[Equation 1]

E=∫_{-∞}^{∞|{}D(t)−Gr(t)}*H(t)|²dt=∫_{-∞}^{∞}|{D(f)′−Gr(f)′}H(f)′|²df

where, * represents a convolution, D(t) represents a data signal recovered by the CDR unit 140, G represents an amplification gain of the inverting amplifier 164, r(t) represents an input optical signal for measurement after conversion into an electrical signal, H(t) represents a transfer function of the band pass filter 167, and ‘represents a Fourier transform.

In the above equation 1, the amplification gain G of the inverting amplifier 164 is set to such a value so as to minimize the power E measured by the radio-frequency power detector 168. As seen from the equation 1, the power E measured by the radio-frequency power detector 168 varies with the difference between the strength of the input data signal and that of the data signal recovered by the CDR unit 140 when the difference is at a passband of the band pass filter 167. In general terms, the higher the signal-to-noise ratio (SNR), or equivalently the smaller the signal distortion, of the input optical signal, the smaller the difference between the waveform of the recovered data signal and the input optical signal. Since the difference between D(t) and Gr(t) in the equation 1 increases when the quality of the optical signal is deteriorated due to noise or distortion, deterioration in the quality of the input optical signal can be monitored at the passband of the band pass filter 167.

When the input optical signal has a lower signal-to-noise ratio or a larger signal distortion, errors in the data signal recovered by the CDR unit 140 increase with jitter therein, causing the CDR unit 140 to decide and output a bit different from that transmitted from the transmitter. In this case, the decided D(t) signal has a waveform significantly different from that of the input optical signal with deterioration resulting from noise or distortion, so the quality of the optical signal can reliably be monitored using such a difference.

In particular, since the band pass filter 167 passes only a specific frequency band, excellent monitoring performance can be maintained even through the CDR unit 140 and the inverting amplifier 164 have significantly different bandwidths and transfer functions. In this connection, the inverting amplifier 164 can be implemented with a narrowband inverting amplifier operable only in the passband of the band pass filter 167.

Moreover, the optical signal quality can be monitored more simply and conveniently at a lower cost irrespective of a frame type of the optical signal. Further, time required for measurement of the quality of the optical signal can be reduced by monitoring the optical signal quality through the comparison of the recovered analog data signal with the inverted/amplified signal without analyzing frame information of the optical signal one by one.

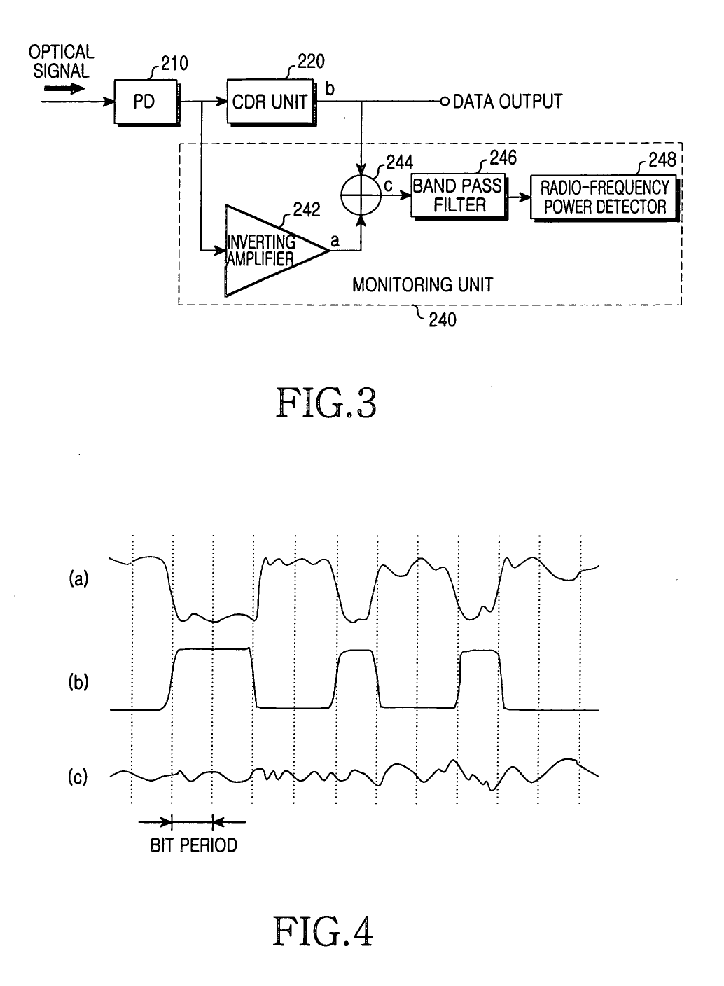

A second embodiment of the optical signal quality monitoring apparatus in accordance with the present invention and exemplified in FIG. 3 includes the PD 120, the CDR unit 140, and a monitoring unit 240 that features the inverting amplifier 164, the adder 166, the band pass filter 167 and the radio-frequency power detector 168. The second embodiment of FIG. 3 is different from the first embodiment of FIG. 2 in that it employs only one PD 120. Therefore, as compared with the first embodiment of FIG. 2, the second embodiment of FIG. 3 can implement the optical signal quality monitoring apparatus more economically by reducing the number of PDs.

FIG. 4a shows, with respect to the FIG. 2 or 3, a waveform of a signal from the inverting amplifier 164 and a data signal b from the CDR unit 140. FIG. 4c shows a waveform of a signal c from the adder 166.

As seen from FIG. 4a, the output optical signal from the inverting amplifier 164 or 242 has a waveform with a large degree of variation due to deterioration in the input optical signal resulting from noise or distortion. The recovered data signal from the CDR unit 140 has a waveform with no significant variation as shown in FIG. 4b even when the input optical signal is deteriorated due to noise or distortion. The result of these two signals added by the adder 166 has a power level proportioned to the amount of noise or distortion contained in the input optical signal.

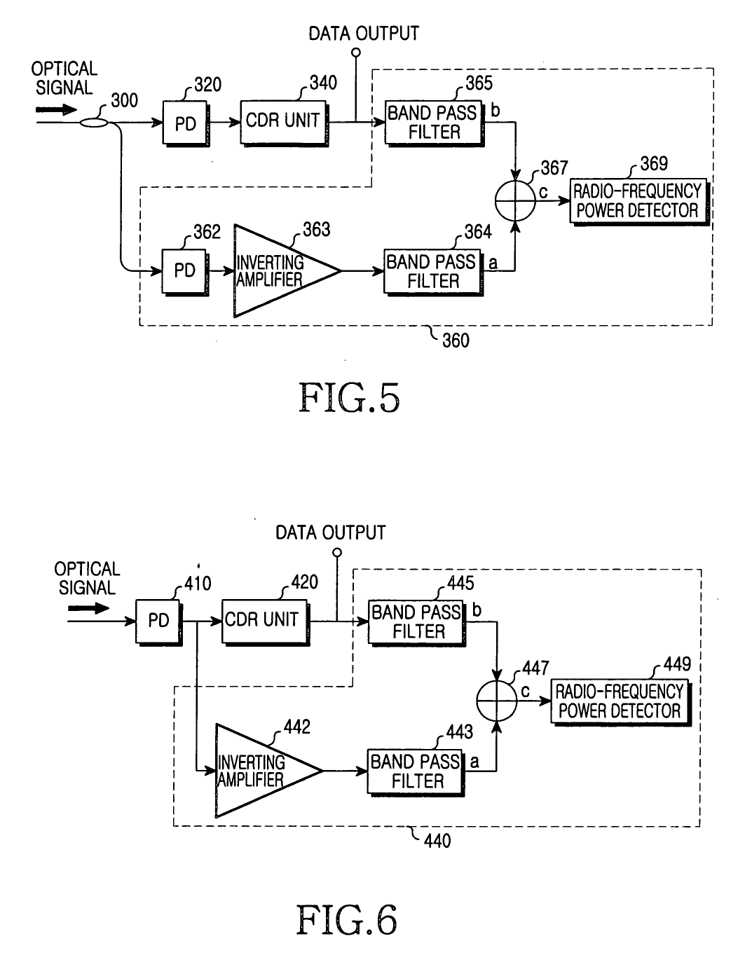

FIG. 5 depicts an example of a third embodiment of the optical signal quality monitoring apparatus in accordance with the present invention which differs from the first embodiment in that it is implemented with two band pass filters 364, 365. The optical signal quality monitoring apparatus comprises the optical coupler 100, the PD 120, the CDR unit 140 and a monitoring unit 360. The monitoring unit 360 includes the PD 162, the inverting amplifier 164, band pass filters 364, 365, the adder 166, and the radio-frequency power detector 168.

FIG. 6 illustrates an exemplary fourth embodiment of the optical signal quality monitoring apparatus in accordance with the present invention that differs from the second embodiment in that it is implemented with two band pass filters 443, 445. The optical signal quality monitoring apparatus comprises the PD 120, the CDR unit 120 and a monitoring unit 440. The monitoring unit 440 includes the inverting amplifier 164, band pass filters 443, 445, the adder 166 and a radio-frequency power detector 168. The fourth embodiment is also similar to the third embodiment, but differs in that it employs only one PD 410. Therefore, as compared with the third embodiment of FIG. 5, the fourth embodiment of FIG. 6 can implement the optical signal quality monitoring apparatus more economically by reducing the number of PDs.

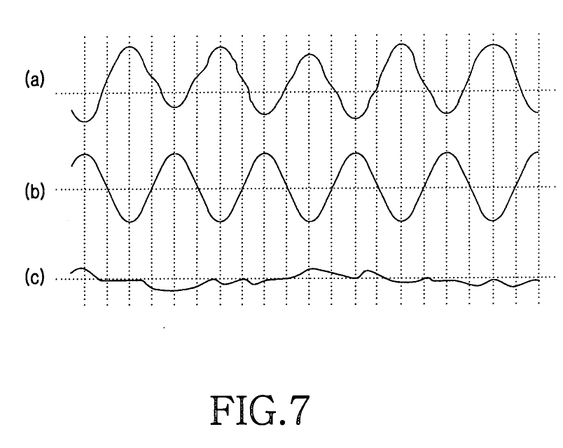

FIG. 7a shows a waveform of a signal a from the band pass filter 364 or 443, FIG. 7b shows a waveform of a signal b from the band pass filter 365 or 445, and FIG. 7c shows a waveform of a signal c from the adder 166. As seen from FIG. 7a, the output optical signal, inverted/amplified by the inverting amplifier 164 and then band pass filtered by the band pass filter 364 or 443, has a waveform with a large degree of variation due to deterioration in the input optical signal resulting from noise or distortion. The data signal, recovered by the CDR unit 140 and then band pass filtered by the band pass filter 365 or 445, has a waveform with no significant variation as shown in FIG. 7b even when the input optical signal is deteriorated due to noise or distortion. The result of these two signals added by the adder 367 or 447 has a power level proportioned to the amount of noise or distortion contained in the input optical signal.

As apparent from the above description, the present invention provides an optical signal quality monitoring apparatus which is capable of monitoring the quality of an optical signal by converting the optical signal into an electrical signal, recovering a data signal from the converted electrical signal while inverting/amplifying the converted electrical signal, synthesizing the recovered data signal with the inverted/amplified signal to obtain a difference there between, band pass filtering the obtained difference and measuring radio-frequency power from the filtered result. Therefore, the optical signal quality can be monitored more simply and conveniently at a lower cost irrespective of a frame type of the optical signal.

Moreover, time required for measurement of the quality of the optical signal can be reduced by monitoring the optical signal quality through the comparison of the recovered analog data signal with the inverted/amplified signal without analyzing frame information of the optical signal one by one.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical Signal quality monitoring apparatus comprising:
an optical coupler for performing a coupling operation for an input optical signal;
a photodetector (PD) for converting said input optical signal into an electrical signal;
a clock decision recovery (CDR) unit for detecting a clock from the electrical signal from said PD and recovering data on the basis of the detected clock; and
monitoring unit for converting an output optical signal from said optical coupler into an electrical signal, subtracting the converted signal from a recovered data signal by said CDR unit, band pass filtering the resulting difference signal, and measuring radio-frequency power from the filtered result, said radio-frequency power being an error value of said input optical signal.

2. The apparatus of claim 1, wherein said monitoring unit includes:
a second PD for receiving an output optical signal from said optical coupler and converting the received optical signal into an electrical signal;
an inverting amplifier for amplifying the electrical signal from said second PD to said predetermined level and inverting the amplified signal;
an adder for adding the amplified/inverted signal from said inverting amplifier to said recovered data signal from said CDR unit to obtain said difference signal;
a band pass filter for performing a band pass filtering operation of passing an output signal from said adder at a predetermined band; and
a radio-frequency power detector for measuring said radio-frequency power from an output signal from said band pass filter.

3. The apparatus of claim 2, further comprising a processor, communicatively connected to the radio-frequency power detector, having a display screen for notifying a user of said error value.

4. The apparatus of claim 2, further comprising a processor, communicatively connected to the radio-frequency power detector, having storage for logging said error value.

5. The apparatus of claim 2, further comprising a processor, communicatively connected to the radio-frequency power detector, configured for determining a source of said error value.

6. An optical signal quality monitoring apparatus comprising:
a PD for converting an input optical signal into an electrical signal;
a CDR unit for detecting a clock from the electrical signal from said PD and recovering data on the basis of the detected clock; and
monitoring unit for inverting/amplifying the electrical signal from said PD to a predetermined level, synthesizing the inverted/amplified signal with a recovered data signal from said CDR unit to obtain a difference between said inverted/amplified signal and said recovered data signal, band pass filtering the resulting difference signal and measuring radio-frequency power from the filtered result, said radio-frequency power being an error value of said input optical signal.

7. The apparatus of claim 6, wherein said monitoring unit includes:
an inverting amplifier for amplifying the electrical signal from said PD to said predetermined level and inverting the amplified signal;
an adder for adding the amplified/inverted signal from said inverting amplifier to said recovered data signal from said CDR unit to obtain said difference signal;
a band pass filter for performing a band pass filtering operation of passing an output signal from said adder at a predetermined band; and
a radio-frequency power detector for measuring said radio-frequency power from an output signal from said band pass filter.

8. The apparatus of claim 7, further comprising a processor, communicatively connected to the radio-frequency power detector, having a display screen for notifying a user of said error value.

9. The apparatus of claim 7, further comprising a processor, communicatively connected to the radio-frequency power detector, having storage for logging said error value.

10. The apparatus of claim 7, further comprising a processor, communicatively connected to the radio-frequency power detector, configured for determining a source of said error value.

11. An optical signal quality monitoring apparatus comprising:
an optical coupler for performing a coupling operation for an input optical signal;
a PD for converting said input optical signal into an electrical signal;
a CDR unit for detecting a clock from the electrical signal from said PD and recovering data on the basis of the detected clock; and
monitoring unit for converting an output optical signal from said optical coupler into an electrical signal, inverting/amplifying the converted electrical signal to a predetermined level, band pass filtering the inverted/amplified signal and a recovered data signal from said CDR unit, respectively, synthesizing the filtered results to obtain a difference between the filtered inverted/amplified signal and the filtered recovered data signal, and measuring radio-frequency power from the resulting difference signal, said radio-frequency power being an error value of said input optical signal.

12. The apparatus of claim 11, wherein said monitoring unit includes:
a second PD for receiving the output optical signal from said optical coupler and converting the received optical signal into an electrical signal;
an inverting amplifier for amplifying the electrical signal from said second PD to said predetermined level and inverting the amplified signal;
a first band pass filter for performing a band pass filtering operation of passing an output signal from said inverting amplifier at a predetermined band;
a second band pass filter for performing a band pass filtering operation of passing said recovered data signal from said CDR unit at said predetermined band;
an adder for synthesizing output signals from said first and second band pass filters to obtain said difference signal; and
a radio-frequency power detector for measuring said radio-frequency power from an output signal from said adder.

13. The apparatus of claim 12, further comprising a processor, communicatively connected to the radio-frequency power detector, having a display screen for notifying a user of said error value.

14. The apparatus of claim 12, further comprising a processor, communicatively connected to the radio-frequency power detector, having storage for logging said error value.

15. The apparatus of claim 12, further comprising a processor, communicatively connected to the radio-frequency power detector, configured for determining a source of said error value.

16. An optical signal quality monitoring apparatus comprising:
a PD for converting an input optical signal into an electrical signal;
a CDR unit for detecting a clock from the electrical signal from said PD and recovering data on the basis of the detected clock; and
monitoring unit for inverting/amplifying the electrical signal from said PD to a predetermined level, band pass filtering the inverted/amplified signal and a recovered data signal from said CDR unit, respectively, synthesizing the filtered results to obtain a difference between the filtered inverted/amplified signal and the filtered recovered data signal, and measuring radio-frequency power from the resulting difference signal, said radio-frequency power being an error value of said input optical signal.

17. The apparatus of claim 16, wherein said monitoring unit includes:
an inverting amplifier for amplifying the electrical signal from said PD to said predetermined level and inverting the amplified signal;
a first band pass filter for performing a band pass filtering operation of passing an output signal from said inverting amplifier at a predetermined band;
a second band pass filter for performing a band pass filtering operation of passing said recovered data signal from said CDR unit at said predetermined band;
an adder for synthesizing output signals from said first and second band pass filters to obtain said difference signal; and
a radio-frequency power detector for measuring said radio-frequency power from an output signal from said adder.

18. The apparatus of claim 17, further comprising a processor, communicatively connected to the radio-frequency power detector, having a display screen for notifying a user of said error value.

19. The apparatus of claim 17, further comprising a processor, communicatively connected to the radio-frequency power detector, having storage for logging said error value.

20. The apparatus of claim 17, further comprising a processor, communicatively connected to the radio-frequency power detector, configured for determining a source of said error value.
